(19) United States
(12) Patent Application Publication
(10) Pub. No.: US 2005/0035855 A1
(43) Pub. Date: Feb. 17, 2005

(54) Voice command system for remote control and monitoring of home networked devices

(75) Inventor: Melvin J. Sarnowsky, Livonia, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/909,065

(22) Filed: Jul. 30, 2004

Related U.S. Application Data
(60) Provisional application No. 60/494,269, filed on Aug. 11, 2003.

(51) Int. Cl. G08B 1/00

(52) U.S. Cl. 340/531; 340/825.72

(57) ABSTRACT

The present invention provides a voice activated system for remote monitoring and control of home networked devices. The system includes a vehicle subsystem with a microphone that receives voice commands from an occupant of the vehicle, a computing platform that processes the voice commands into command signals transmitted over a wireless network, and a display that provides a visual interface between the occupant and the vehicle subsystem to display the commands. The system also includes a home subsystem with a server that directly receives the command signals over the wireless network, interprets the command signals, and issues instruction commands to the appropriate networked devices.

### RELATED APPLICATION

This application claims the benefit of U.S. Provisional Application No. 60/494,269, filed Aug. 11, 2003, the entire contents of which are incorporated herein by reference.

### BACKGROUND

The present invention generally relates to a system that monitors and controls networked devices in a home. More specifically, the invention relates to a voice command system for remote control and monitoring of devices in a home.

Recently, systems have appeared in motor vehicles that allow an occupant of a vehicle to initiate commands that are transmitted to the occupant's home to activate devices networked together in the home. For example, one system integrates a virtual advisor service to provide an interface for the occupant to control systems within the home, such as lighting, climate, and home security systems. The interface utilizes a personal calling service with voice recognition technology. Such systems, however, rely on a third party as an intermediary to receive the occupant's requests and transfer the requests to the home network.

Certain systems utilize multiple push buttons in the vehicle to control networked home devices. In such systems, each button is dedicated to a specific command. Other systems implement touch screens in a display to initiate commands. All of these approaches, however, distract the driver since the driver has to locate the appropriate button in the vehicle or has to scroll through multiple screens in the display to issue the commands.

In view of the above, it is apparent that there exists a need to remotely monitor and control networked home devices from a vehicle through voice-initiated commands that are processed and directly transmitted over a wireless network from the vehicle to the home without the need of a third party intermediary.

### SUMMARY

In satisfying the above need, as well as overcoming the enumerated drawbacks and other limitations of the related art, the present invention provides a system and method for monitoring and controlling home networked devices with voice commands. The system includes a vehicle subsystem with a microphone that receives voice commands from an occupant of the vehicle, a computing platform that processes the voice commands into command signals transmitted over a wireless network, and a display that provides a visual interface between the occupant and the vehicle subsystem to display the commands. The system also includes a home subsystem with a server that directly receives the command signals over the wireless network, interprets the command signals, and issues instruction commands to the appropriate networked devices.

In various embodiments, the server monitors the performance activities of the networked devices. The performance activities are transmitted over the wireless network directly to the vehicle subsystem, and the computing platform processes the performance information and transmits the performance information to the display.

In particular embodiments, the occupant initiates the vehicle subsystem with a push-to-talk button positioned within reach of the occupant. The button can be a virtual button on the display. The vehicle subsystem may include an audio system that provides an audio interface between the vehicle subsystem and the occupant.

In certain embodiments, the vehicle subsystem includes a wireless gateway that provides an interface between the vehicle subsystem and the wireless network, and the home subsystem includes a wireless access point that provides an interface between the home subsystem and the wireless network.

Various embodiments of the invention may provide one or more of the following advantages. Instead of only using multiple buttons or a touch screen to initiate commands, the system utilizes voice commands and a push-to-talk button to minimize driver distraction while driving, since the driver does not have to scroll through multiple screens on the display or locate the appropriate button in the vehicle.

The system does not have to be trained to correctly interpret the voice commands spoken by new users since the commands are selected in a manner that maximizes the phonetic differences between these commands.

The system provides a corresponding audible response, and the corresponding screen is shown on the in-vehicle display with the appropriate action indicated such that occupant knows whether or not the vehicle subsystem responded correctly to the voice command.

Instead of requiring the use of a third party as an intermediary to receive the occupant's requests and transfer them to the networked home, the system processes the voice commands of the occupant and transfers the commands directly from the vehicle over a wireless network to the home system, which is less costly and more convenient to the user.

A virtual push-to-talk button on a display screen in the vehicle eliminates the need for an actual switch and associated routing wires through, for example, the steering column, which can be difficult to accommodate depending on the number of other wires located in the steering column.

Further features and advantages of this invention will become readily apparent from the following description and claims.

### BRIEF DESCRIPTION OF THE DRAWINGS

FIG. 1 is a schematic of a voice control system to monitor and control devices in a home in accordance with the invention;

FIG. 2 is a block diagram of the components of the voice control system; and

FIG. 3 is a flow diagram of a sequence of steps performed to operate the voice control system.

### DETAILED DESCRIPTION

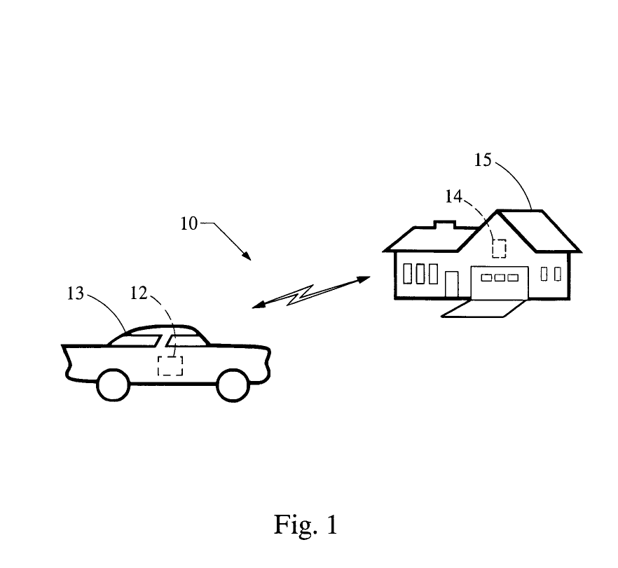

Referring now to FIG. 1, a system embodying the principles of the present invention is illustrated therein and designated at 10. The system 10 enables an occupant, such as a driver or passenger, residing in a vehicle 13 to remotely monitor and control networked home devices in a home 15 from the vehicle 13 through voice-initiated commands that are processed and directly transmitted over a wireless network from the vehicle 13 to the home 15.

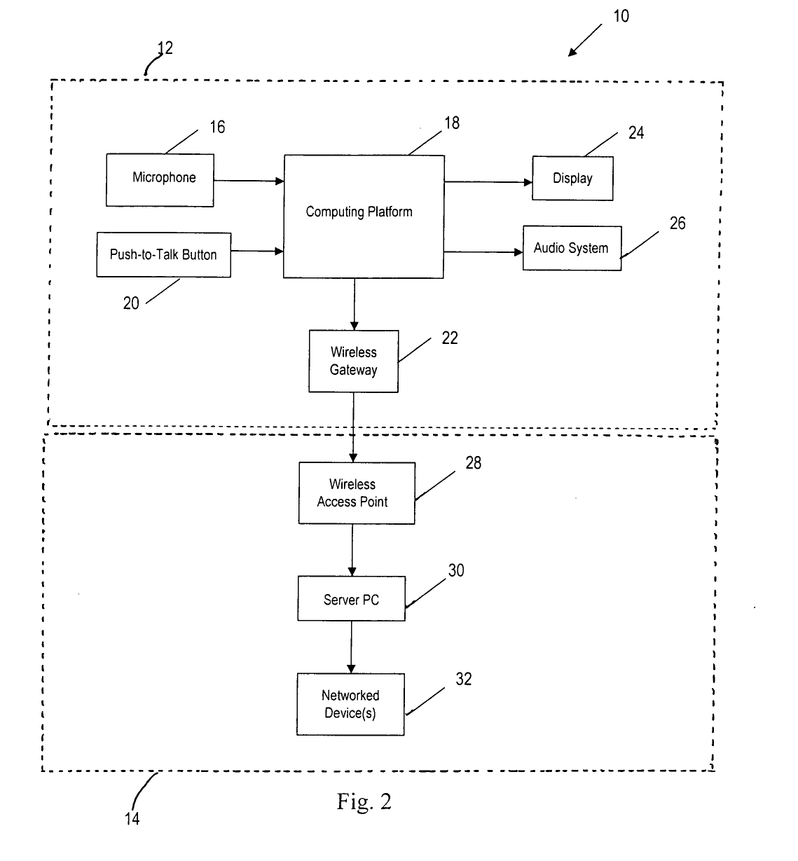

Referring also to FIG. 2, as its primary components, the system 10 includes a vehicle subsystem 12 and a home subsystem 14. The vehicle subsystem 12 includes a microphone 16, a computing platform 18, such as a microprocessor, a push-to-talk button 20, a wireless gateway 22, a display 24, and an audio system 26 all of which are residing in the vehicle 13.

The microphone 16 is located, for example, in the headliner in the front of the passenger compartment of the vehicle and enables the occupant to communicate with the vehicle subsystem 12. The computing platform 14 provides hardware interfaces for the microphone 16, the button 20, the display 24, and the wireless gateway 22. An algorithm is implemented in the computing platform 18 to enable the computing platform 18 to store and execute software for operating the vehicle subsystem 12.

The button 20 can be a push-to-talk button within reach of the occupant that the occupant actuates by merely pushing the button. In particular implementations, the button 20 is a virtual momentary switch on the display 24. Such a switch eliminates the need for an actual switch and associated routing wires through, for example, the steering column, which can be difficult to accommodate depending on the number of other wires located in the steering column.

The wireless gateway 22 provides an interface between the vehicle subsystem 12 and the wireless network. The display 24 is located, for example, in the instrument panel and provides a visual interface between the occupant and the vehicle subsystem 12, and the audio system 26 includes, for example, audio amplifier(s) and speakers that provide an audio interface between the occupant and the vehicle subsystem 12.

The home subsystem 14 is networked within the home and includes a wireless access point 28, a server 30, such as a PC, and one or more networked devices 32, such as components of entertainment, security, lighting, or climate control systems. The wireless access point 28 provides an interface between the home subsystem 14 and the wireless network. Software is stored and executed in the server 30 to enable it to operate the home subsystem 14.

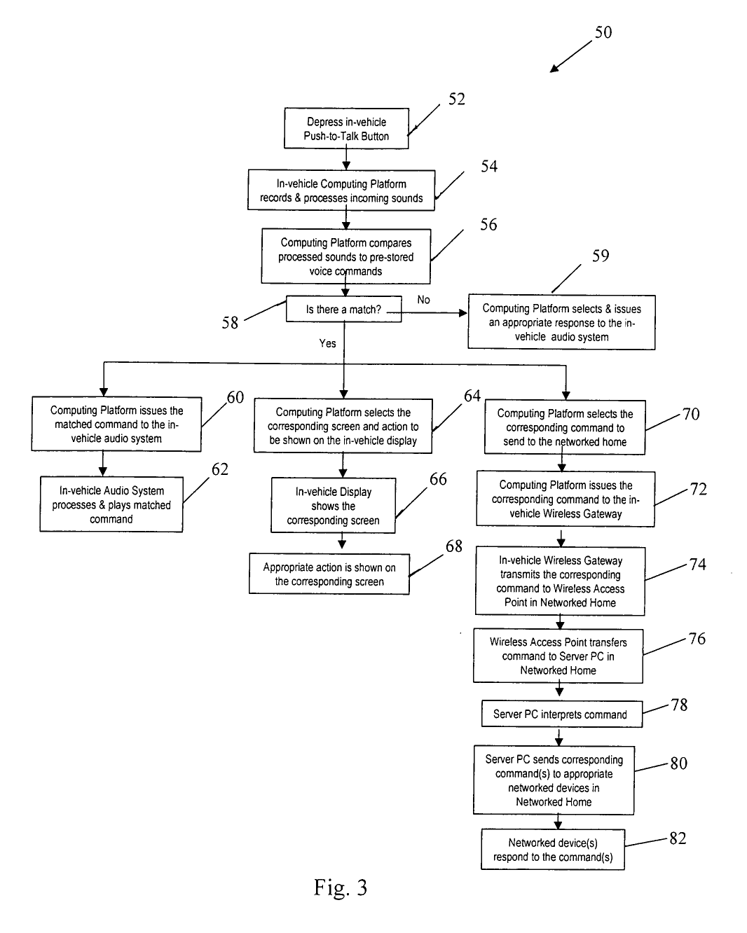

Referring now to FIG. 3, as well as to FIGS. 1 and 2, there is shown a block diagram of a process 50 for operating the system 10. In step 52, the occupant activates the process 50 by depressing the button 20 such that the computing platform 18 begins capturing audio input from the occupant through the microphone 16. After the audio input capture phase times out, in step 54 the computing platform 18 processes the incoming sounds and in step 56 then compares the processed signal with the voice commands that have been pre-stored into the memory of the computing platform 18. The system 10 does not have to be trained to correctly interpret the voice commands spoken by new users since the commands are selected in a manner that maximizes the phonetic differences between these commands.

The process 50 then proceeds to step 58 which determines whether or not there is a match made from the comparison in step 56. If there is no match, then in step 59 the computing platform 18 issues an appropriate response to the audio system 26 informing the occupant that a match did not occur.

On the other hand, if step 58 determines there is a match between the processed sounds and the pre-stored voice commands, then the following sequence of events occur. In step 60, the computing platform 18 issues the matched voice command from its memory to the audio system 26 to provide an audible confirmation of the command, and in step 62 the audio system 26 processes and plays the command. Meanwhile, in step 64, the computing platform 18 selects the corresponding screen for the display 24, which in steps 66 and 68 shows this screen with the appropriate action based on the matched command to provide visual feedback to the occupant that a match did occur. Thus, the system 10 provides a corresponding audible response to the command, and the corresponding screen is shown on the in-vehicle display 24 with the appropriate action indicated such that occupant knows whether or not the vehicle subsystem 12 responded correctly to the voice command.

Based on the matched command, in step 70, the computing platform 18 selects the appropriate command to send to the networked home subsystem 14, and then in step 72 issues this command signal through the wireless gateway 22 of the vehicle subsystem 12. Next, in step 74, the wireless gateway 22 transmits the command signal over the wireless network directly to the wireless access point 28 of the home subsystem 14 without the use of a third party intermediary.

Subsequently, in step 76, the wireless access point 28 transfers the command to the server 30, which, in step 78, interprets the command. Then in step 80 the server 30 sends instruction commands to the appropriate networked device(s) 32, which respond to the commands in step 82.

Referring specifically now to FIGS. 1 and 2, the system 10 also enables the occupant of the vehicle 13 to monitor the activities of the networked devices 32. The sever 30 interprets these activities to determine the performance of the networked devices 32. The wireless access point 28 transmits the performance of the devices over the wireless network to the wireless gateway 22. The computing platform 18 then receives this information from the wireless gateway 22, processes the information, and transmits the information to the display 24, which exhibits the performance of the networked devices 32 to the occupant. Performance information may also be provided as audio signals through the audio system 26. Thus, the system 10 enables the occupant of the vehicle 13 to monitor and control networked home devices via signals that are processed and directly transmitted over a wireless network between the vehicle 13 and the home 15.

As a person skilled in the art will readily appreciate, the above description is meant as an illustration of an implementation of the principles of this invention. This description is not intended to limit the scope or application of this invention in that the invention is susceptible to modification, variation and change, without departing from spirit of this invention, as defined in the following claims.

1. A system for monitoring and controlling home networked devices from a motor vehicle comprising:
a vehicle subsystem including
a microphone that receives voice commands from an occupant of the vehicle;
a computing platform that processes the voice commands into command signals transmitted over a wireless network; and
a display that provides a visual interface between the occupant and the vehicle subsystem to display the commands; and
a home subsystem including
a server that directly receives the command signals over the wireless network, interprets the command signals, and issues instruction commands to the appropriate networked devices.

2. The system of claim 1 wherein the server monitors the performance activities of the networked devices, the performance activities being transmitted over the wireless network directly to the vehicle subsystem, the computing platform processing the performance information and transmitting the performance information to the display.

3. The system of claim 1 wherein the vehicle subsystem includes a button activated by the occupant to initiate the system.

4. The system of claim 3 wherein the button is a virtual button in the display.

5. The system of claim 3 wherein the button is located within reach of the occupant.

6. The system of claim 1 wherein the vehicle subsystem includes an audio system that provides an audio interface between the vehicle subsystem and the occupant.

7. The system of claim 1 wherein the vehicle subsystem includes a wireless gateway that provides an interface between the vehicle subsystem and the wireless network.

8. The system of claim 1 wherein the home subsystem includes a wireless access point that provides an interface between the home subsystem and the wireless network.

9. The system of claim 1 wherein the voice commands are selected in a manner that maximizes the phonetic differences between the commands to eliminate the need to train the system to interpret voice commands of different occupants.

10. The system of claim 1 wherein the command signals are transmitted directly over a wireless network between the vehicle and home without the use of a third party intermediary.

11. A method for monitoring and controlling home networked devices from a motor vehicle comprising:
receiving voice commands from an occupant of the vehicle with a microphone located in the vehicle;
processing the voice commands into command signals with a computing platform located in the vehicle;
displaying the commands in a display;
transmitting the command signals over a wireless network;
receiving the command signals with a server located in the home;
interpreting the command signals with the server; and
issuing instruction commands from the server to the appropriate networked devices.

12. The method of claim 11 further comprising monitoring the performance activities of the networked devices with the server, transmitting the performance activities over the wireless network, the computing platform processing the performance information and transmitting the performance information to the display.

13. The method of claim 11 further comprising activating the control of the networked devices by depressing a button located in the vehicle.

14. The method of claim 13 wherein the button is a virtual button in the display.

15. The method of claim 11 further comprising providing an audio system as an audio interface with the occupant.

16. The method of claim 11 further comprising transmitting the command signals from a wireless gateway located in the vehicle.

17. The method of claim 11 further comprising receiving the command signals with a wireless access point located within the home.

18. The method of claim 11 wherein the voice commands are selected in a manner that maximizes the phonetic differences between the commands to eliminate the need to train the system to interpret voice commands of different occupants.

19. The method of claim 11 wherein the command signals are transmitted directly over a wireless network between the vehicle and home without the use of a third party intermediary.
